(19) United States
(12) Patent Application Publication
(10) Pub. No.: US 2010/0224617 A1
(43) Pub. Date: Sep. 9, 2010

(54) SEPARABLE HEATING DEVICE OF ROASTING OVEN

(76) Inventor: Kuei-Tang CHANG, Banchiau City (TW)

Correspondence Address: HDLS Patent & Trademark Services, P.O. BOX 220746, CHANTILLY, VA, 20153-0746, US

(21) Appl. No.: 12/400,271

(22) Filed: Mar. 9, 2009

(51) Int. Cl. A21B 1/00

(52) U.S. Cl. 219/402

(57) ABSTRACT

A separable heating device of roasting oven closely covers on an oven body of the roasting oven and includes a lid plate, an electrically heating module and a quickly-releasing mechanism. The lid plate is arranged an open hole; the electrically heating module is disposed corresponding to the open hole and its one side faces to an interior of the oven body; and, the quickly-releasing mechanism is fixed securely to the electrically heating module and makes the electrically heating module connected to the lid plate in a separable manner, such that the electrically heating module and the lid plate can be assembled and separated quickly, facilitating in wash and promoting convenience of use.

### BACKGROUND OF THE INVENTION

1. Field of the Invention

The present invention in general relates to a heating device, in particular, to a separable heating device of roasting oven.

2. Description of Prior Art

According to the prior art, a heating from microwave oven or roasting oven is the quick way to heat food ingredients or foods that had been frozen or refrigerated. However, the use of microwave has a radiative problem so, when in operation, the user has to keep a sufficient distance from the microwave oven to prevent the hurt of radiation. When a roasting oven is in use, a tinfoil paper is usually laid on the food tray of the roasting oven but, under the highly heating temperature, the tinfoil paper may be deteriorated to emit chemicals harmful to the human body.

Therefore, without the drawbacks of the two heating manners mentioned therein before, the industry has developed a kind of roasting oven, which includes an oven body, a lid plate and an electrically heating module. According to this kind of prior art, the electrically heating module is inter-fixed with the lid plate, and both of them cover on the oven body to form a chamber in the oven body to accommodate the food ingredients or foods to be heated; when in operation, the electrically heating module will blow air flow of high temperature into the oven body with a generation of convective flow to heat the food ingredients or foods.

However, in terms of practical use, the structure of this kind of roasting oven still exists one problem: since the lid plate and the electrically heating module are inter-fixed by means of screws, it causes inconvenience when cleaning the roasting oven; if the cleaning process is proceeded without separating the electrically heating module from the lid plate, the connecting gaps between the electrically heating module and the lid plate are very difficult to wash and clean; furthermore, the electrically heating module is easily damaged because water may invade into its interior during washing; if we want to separate the electrically heating module from the lid plate for facilitating in washing the lid plate, the fixing screws have to be dismantled one by one, which is a very tedious process, not to mention that the screws has to be screwed back when the wash is finished.

Therefore, how to improve and solve the aforementioned problem is an issue intended to be addressed by the inventor.

Accordingly, after a substantially devoted study, in cooperation with the application of relatively academic principles, the inventor has finally proposed the present invention that is designed reasonably to possess the capability to improve the drawback of the prior art significantly.

### SUMMARY OF THE INVENTION

The invention is mainly to provide a separable heating device of roasting oven, in which a quickly-releasing mechanism connects an electrically heating device and a lid plate together in a separable manner, such that the electrically heating device and the lid plate can be assembled and separated quickly, facilitating in wash and promoting convenience of use.

Secondly, the invention is to provide a separable heating device of roasting oven, which closely covers on an oven body of the roasting oven, and which includes a lid plate, an electrically heating module and a quickly-releasing mechanism, in which the lid plate is arranged an open hole; the electrically heating module is disposed corresponding to the open hole and its one side faces to an interior of the oven body; and, the quickly-releasing mechanism is fixed securely to the electrically heating module and makes the electrically heating module connected to the lid plate in a separable manner.

Compared to the prior arts, the invention has the following advantageous functions: firstly, the drawback of the prior arts, which the electrically heating module can not be assembled to and dismantled from the lid plate quickly, is solved, so the invention is more convenient with respect to wash and use; secondly, by arranging a safe switch, the safe use of the product is promoted.

### BRIEF DESCRIPTION OF DRAWING

The features of the invention believed to be novel are set forth with particularity in the appended claims. The invention itself, however, may be best understood by reference to the following detailed description of the invention, which describes several exemplary embodiments of the invention, taken in conjunction with the accompanying drawings, in which:

FIG. 1 is a perspective explosive view of the invention;

FIG. 2 is a perspective outer view of the invention;

FIG. 3 is a perspective explosive view of the electrically heating module of the invention;

FIG. 4 is an activating status illustration (1) between the electrically heating module and the lid plate of the invention;

FIG. 5 is an activating status illustration (2) between the electrically heating module and the lid plate of the invention;

FIG. 6 is a cross-sectional view along the sectional line “6-6” in FIG. 5;

FIG. 7 is a perspective outer view of another embodiment of the invention;

FIG. 8 is a perspective explosive view of both the electrically heating module and the lid plate according to another embodiment of the invention;

FIG. 9 is a perspective outer view of both the electrically heating module and the lid plate according to another embodiment of the invention;

FIG. 10 is a cross-sectional activating view (1) along the sectional line “10-10” in FIG. 9; and

FIG. 11 is a cross-sectional activating view (2) along the sectional line “10-10” in FIG. 9.

### DETAILED DESCRIPTION OF THE INVENTION

In cooperation with attached drawings, the technical contents and detailed description of the present invention are described thereinafter according to a number of preferable embodiments, not used to limit its executing scope. Any equivalent variation and modification made according to appended claims is all covered by the claims claimed by the present invention.

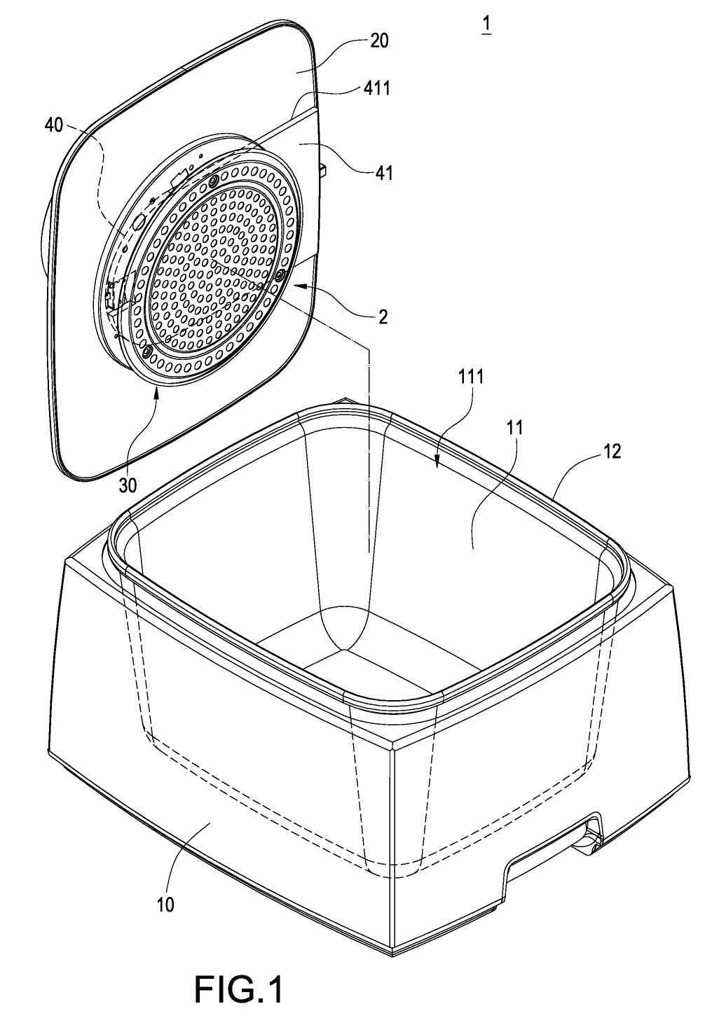

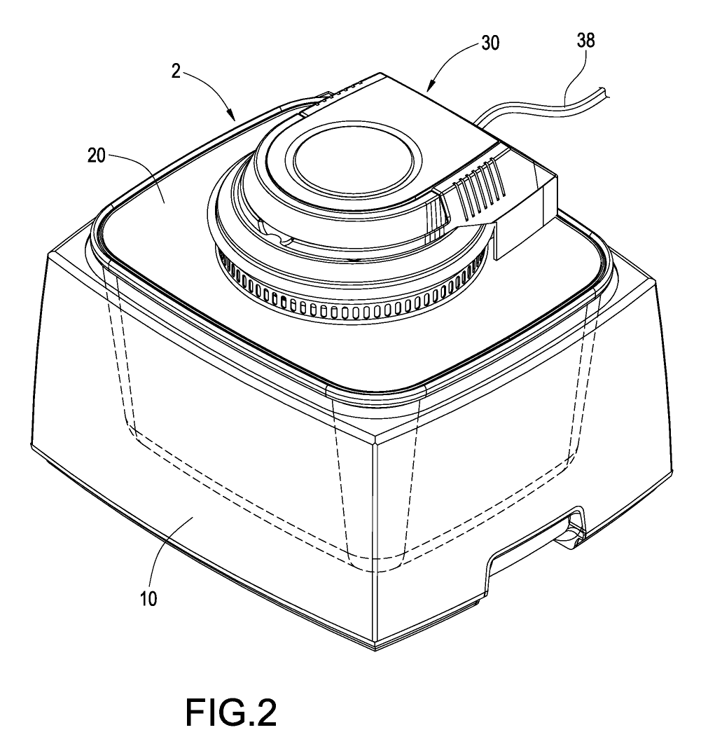

Please refer to FIG. 1 and FIG. 2, which respectively are a perspective explosive view and a perspective outer view of the invention. The invention is mainly to provide a separable heating device 2 of roasting oven 1, which closely covers on an oven body 10 of the roasting oven 1, and which includes a lid plate 20, an electrically heating module 30 and a quickly-releasing mechanism 40.

A chamber 11, formed in the oven body 10, has an outlet 111, around the periphery of which a gasket 12 is formed, which is shown as a ring configuration arranged on top of the oven body 10. The chamber 11 is for accommodating the food to be heated (not shown in the figures). In this embodiment, the oven body 10 is substantially shown as a cuboid, but not limited to this configuration only.

The lid plate 20, the shape of which corresponds to the opening of the chamber 11, closely covers on the oven body 10 and is arranged an open hole 21. In this embodiment, the open hole 21 is arranged at one side of the lid plate 20 and is formed an opening b, making the lid plate 20 shown as a “U” shape, thereby a slide 211 being formed along the open hole 21 of the lid plate 20, but not limited to this configuration only.

The electrically heating module 30, disposed by corresponding to the open hole 21 of the lid plate 20, has one side facing the oven body 10 and is accommodated in the chamber 11. In the meantime, the quickly-releasing mechanism 40 is connected securely to the electrically heating module 30, making both the electrically heating module 30 and the lid plate 20 able to be connected together in a separable manner.

More specifically, in the embodiment, the quickly-releasing mechanism 40 includes two flat plates 41 overlapped to each other and a sliding trough 411 formed between the flat plates 41. The sliding trough 411 can be inset and slid by the slide 211. Since the sliding trough 411 and the slide 211 can be cooperated closely by the friction force, they are assembled tightly without falling off.

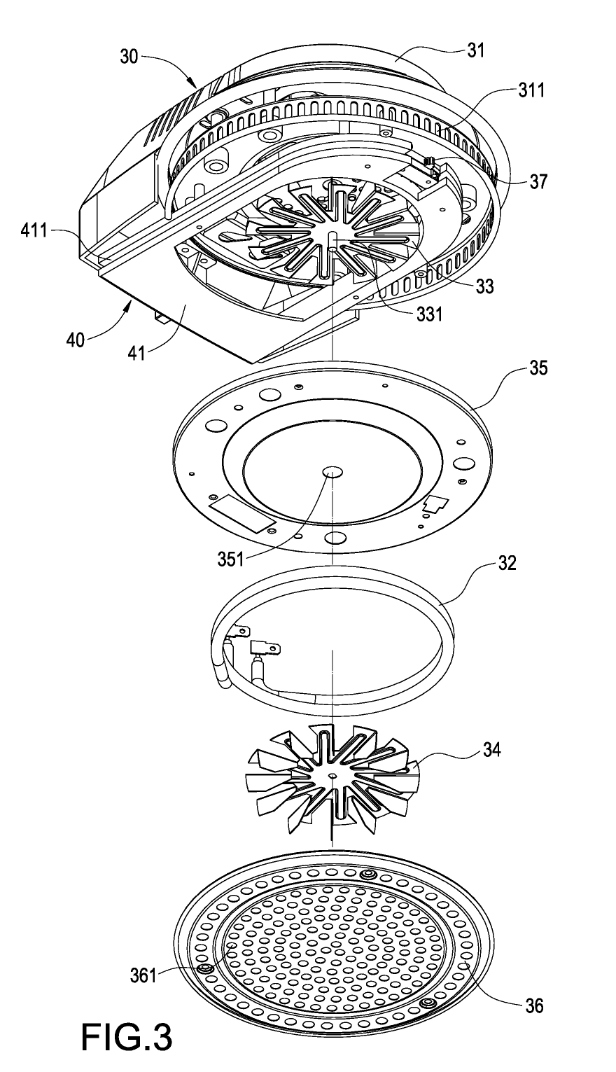

Please refer to FIG. 3, showing a perspective explosive view of the electrically heating module of the invention. The electrically heating module 30 includes a main body 31 having a power-supplying unit (not shown in the figures), an electrically heating pipe 32, a first blade 33, a second blade 34, a thermally insulating plate 35, a protecting plate 36, a safe switch 37 and a power cord 37 electrically connected to the power-supplying unit. In this embodiment, the first blade 33 is pivoted to the bottom of the main body 31 and is extended a rotary axle 331. Corresponding to the first blade 33, the main body 31 is arranged a plurality of cooling holes 311 substantially shown as a ring configuration, while the second blade 34 is pivoted to the rotary axle 331.

Please refer to FIG. 1 and FIG. 2 together. The electrically heating pipe 32, positioned under the main body 31, is electrically connected to the power-supplying unit and is arranged around the periphery of the second blade 34 in a ring configuration.

The thermally insulating plate 35, fixed between the electrically heating pipe 32 and the main body 31, separates the first blade 33 and the second blade 34 and is arranged a perforation 351 corresponding to the rotary axle 331. The function of the thermally insulating plate 35 is to insulate the heat generated from the electrically heating pipe 32 to avoid the main body 31 from overheating and burning down. By the rotation of the first blade 33, the heat is carried out through cooling holes 311, such that the temperature in the main body 31 can be lowered down.

The protecting plate 36, fixed under the thermally insulating plate 35, is arranged a plurality of ventilating holes 361 corresponding to the second blade 34, while the electrically heating pipe 32 is arranged between the thermally insulating plate 35 and the protecting plate 36. By the rotation of the second blade 34, the air of high temperature around the electrically heating pipe 32 is blown into the chamber 11 of the oven body 10 through the ventilating holes 361, heating the food to be roasted (not shown in the figures).

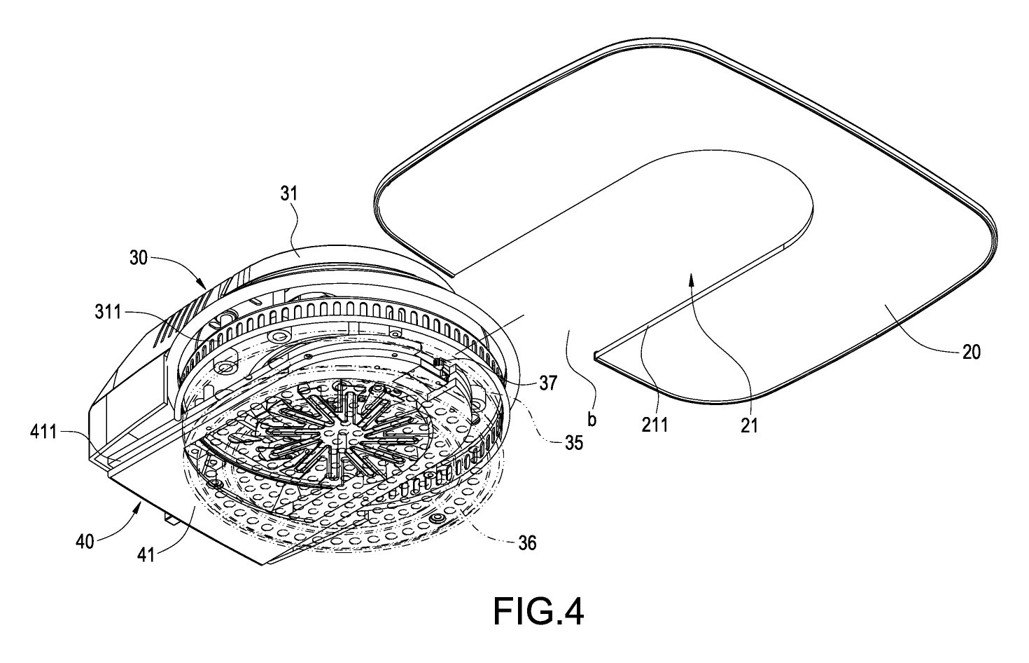

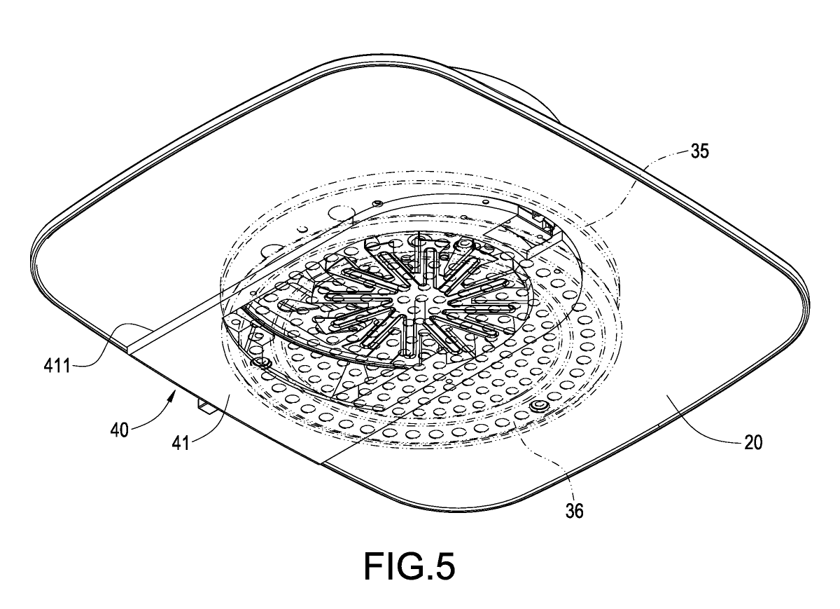

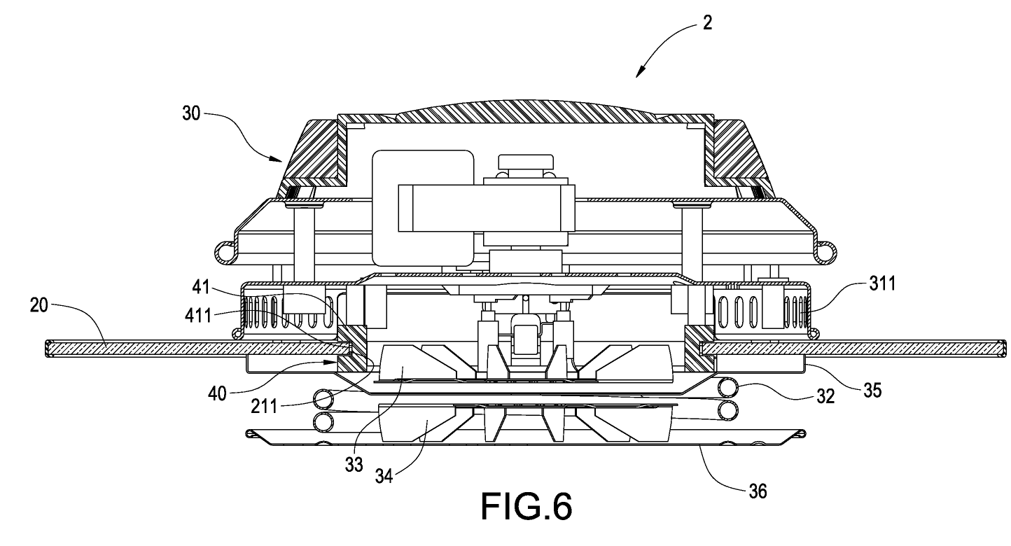

Please refer to FIG. 4 through FIG. 6, separately showing an actuating status illustration (1) of both the electrically heating module and the lid plate of the invention, an actuating status illustration (2) of both the electrically heating module and the lid plate of the invention and a cross-sectional view along the sectional line “6-6” in FIG. 5. In this embodiment, through the inter-slide between the sliding trough 411 and the slide 211, the lid plate 20 and the electrically heating module 30 can be assembled and separated quickly, facilitating the convenience of use.

In addition, the electrically heating module 30 further includes a safe switch 37 fixed on the main body 31. The safe switch 37 is arranged in an electric wiring (not shown in the figures) electrically conducting the power-supplying unit (not shown in the figures) and the electrically heating pipe 32. Through the contact between the lid plate 20 and the safe switch 37, the electric conduction of electric wiring is controlled.

More specifically, when the lid plate 20 is inset into the main body 31 and abutted against the safe switch 37, the electric wiring will be electrically conducted, and then the power-supplying unit of the main body 31 supplies power to the electrically heating pipe 32. On the other hand, if the lid plate 20 is separated from the main body 31, then this electric wiring will be shown as a broken circuit; in other words, the main body 31 does not supply power to the electrically heating pipe 32 any more. Through the arrangement mentioned therein before, the safety in terms of use can be promoted significantly.

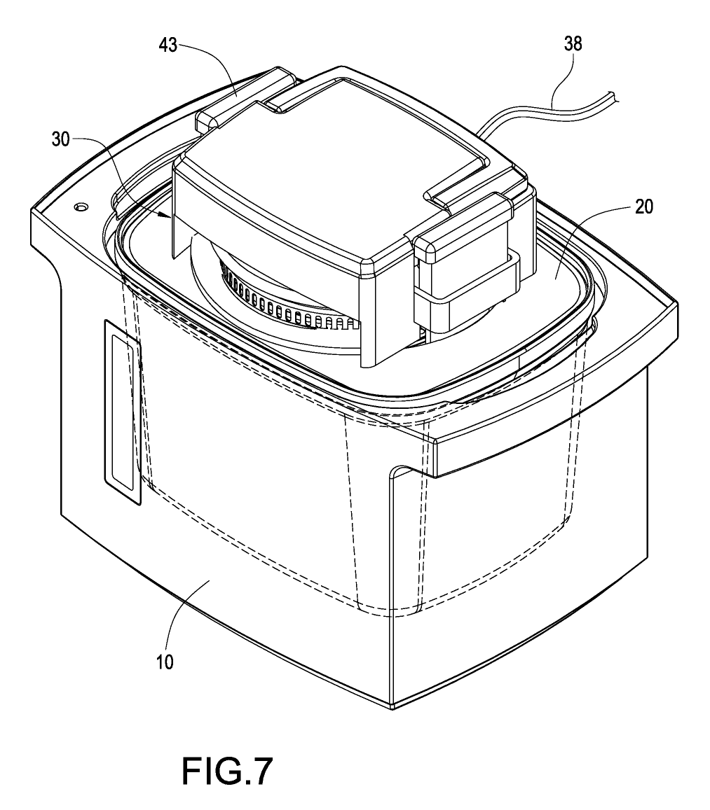

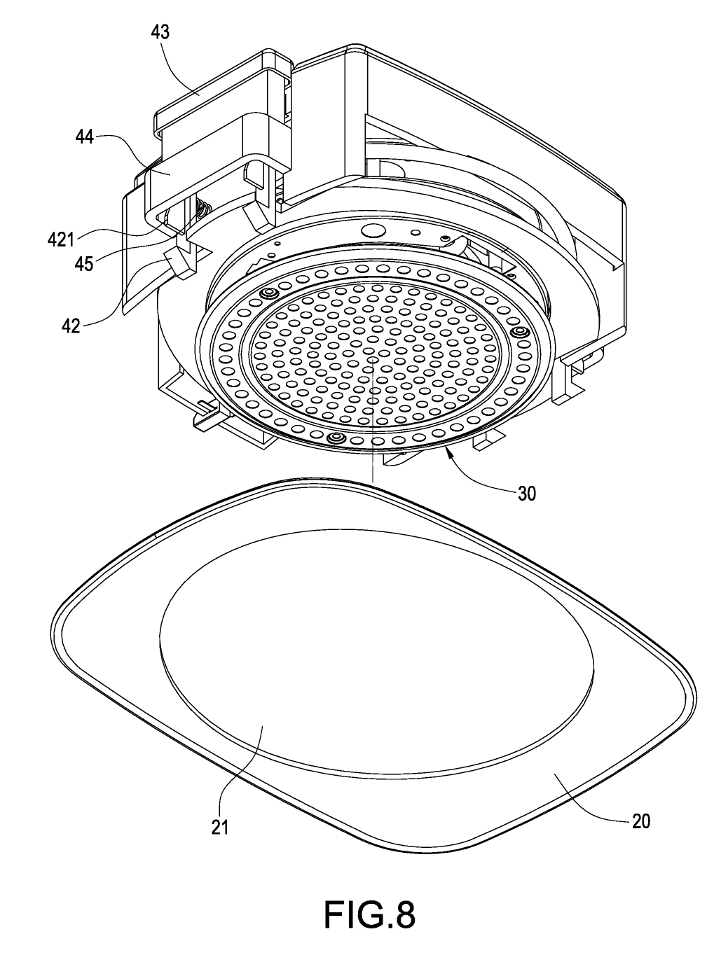

Please refer to FIG. 7 through FIG. 9, separately showing a perspective outer view of another embodiment of the invention, a perspective explosive view of both the electrically heating module and the lid plate according to another embodiment of the invention and a perspective outer view of both the electrically heating module and the lid plate according to another embodiment of the invention. In this embodiment, the open hole 21 vertically penetrates the lid plate 20, and the periphery of the open hole 21 is closed, but not limited to this configuration only.

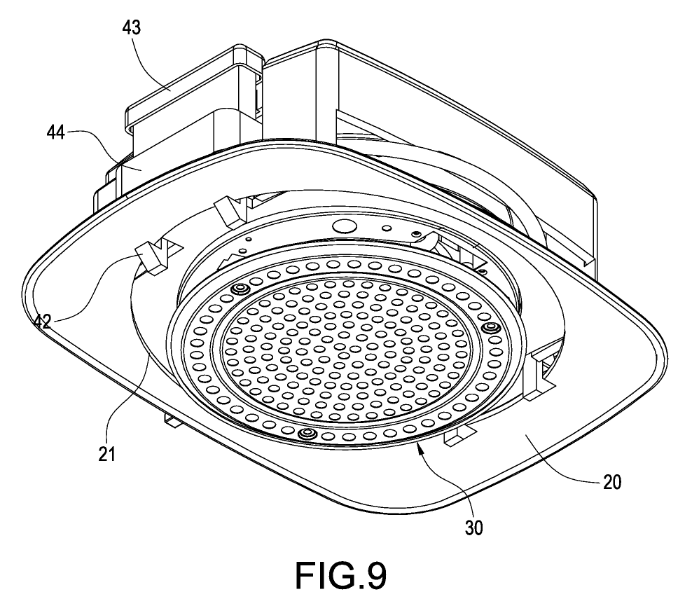

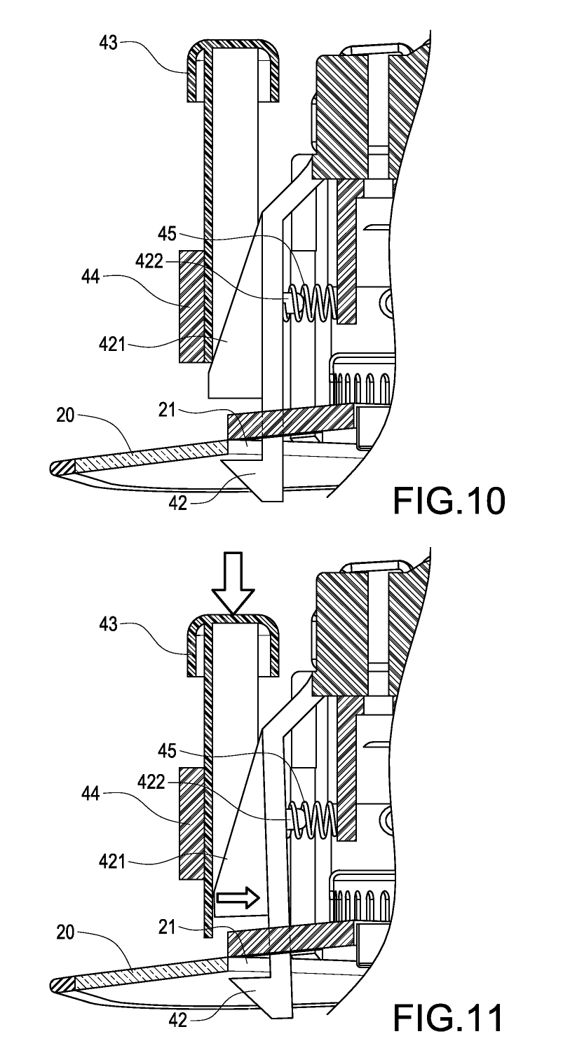

Please refer to FIG. 10 and FIG. 11, respectively showing a cross-sectional actuating view (1) along the sectional line “10-10” in FIG. 9 and a cross-sectional actuating view (2) along the sectional line “10-10” in FIG. 9. In this embodiment, the quickly-releasing mechanism 40 includes a wedge hook 42, a slide block 43 disposed beside the wedge hook 42, a position-limiting ring 44 extended from one side of the main body 31 and a compressive spring 45, in which the wedge hook 42 passes through the open hole 21 and is inter-wedged with the lid plate 20.

The slide block 43 and the wedge hook 42 are accommodated between the position-limiting ring 44 and the main body 31, and the slide block 43 can be slid relatively to the main body 31. In addition, the wedge hook 42 is extended a rib 421 abutted against the slide block 43 and shown as an inclining configuration. Through the sliding motion of the slide block 43 relative to the main body 31, the rib 421 is abutted by the slide block 43, making the wedge hook 42 displaced and separating the lid plate 20.

The compressive spring 45 is sandwiched and held between the wedge hook 42 and the main body 31. The side face of the wedge hook 42 facing the main body 31 is formed a positioning pillar 422 adapted for being fitted in by the compressive spring 45.

When the lid plate 20 and the electrically heating module 30 are being assembled together, the electrically heating module 30 is wedged into the open hole 21, making the wedge hook 42 wedged against the side face of the lid plate 20. In the meantime, the compressive spring 45 will push the wedge hook 42 to the outside, making wedge hook 42 not separated from the lid plate 20. Thereby, it can assemble the lid plate 20 and the electrically heating module 30 together.

When it is going to separate the electrically heating module 30 from the lid plate 20, the slide block 43 is pushed down to abut against the rib 421 in a way, such that the compressive spring 45 is compressed and the wedge hook 42 is moved toward the inner side of the main body 31. Since the wedge hook 42 has already been contracted and disparted from the lid plate 20, the electrically heating module 30 and the lid plate 20 can be separated from each other subsequently.

Summarizing aforementioned description, the invention is an indispensably novel structure for a heating device indeed, which may positively reach the expected usage objective for solving the drawbacks of the prior arts, and which extremely possesses the innovation and progressiveness to completely fulfill the applying merits of new type patent, according to which the invention is thereby applied. Please examine the application carefully and grant it as a formal patent for protecting the rights of the inventor.

However, the aforementioned description is only a number of preferable embodiments according to the present invention, not used to limit the patent scope of the invention, so equivalently structural variation made to the contents of the present invention, for example, description and drawings, is all covered by the claims claimed thereinafter.

What is claimed is:

1. A separable heating device of roasting oven, covering on an oven body of the roasting oven and including
a lid plate, which is arranged an open hole;
an electrically heating module, which is disposed corresponding to the open hole, and a side of which faces to an interior of the oven body; and,
a quickly-releasing mechanism, which is fixed securely to the electrically heating module and makes the electrically heating module connected to the lid plate in a separable manner.

2. The separable heating device of roasting oven according to claim 1, wherein the open hole is arranged at one side of the lid plate and is formed an opening, making the lid plate shown as a “U” shape, thereby a slide being formed along the open hole of the lid plate, and wherein the quickly-releasing mechanism includes two flat plates overlapped to each other and a sliding trough formed between the flat plates and able to be inset and slid by the slide.

3. The separable heating device of roasting oven according to claim 1, wherein the electrically heating module includes a main body having a power-supplying unit, an electrically heating pipe, a first blade and a second blade, and wherein the first blade is pivoted to a bottom of the main body and is extended a rotary axle and, corresponding to the first blade, the main body is arranged a plurality of cooling holes substantially in a ring configuration, and the second blade is pivoted to the rotary axle, and the electrically heating pipe positioned under the main body is electrically connected to the power-supplying unit and is arranged around a periphery of the second blade in a ring configuration.

4. The separable heating device of roasting oven according to claim 3, wherein the electrically heating module further includes a safe switch that is fixed on the main body and is arranged in an electric wiring electrically conducting the power-supplying unit and the electrically heating pipe and, through a contact between the lid plate and the safe switch, the electric conduction of the electric wiring is controlled.

5. The separable heating device of roasting oven according to claim 3, wherein the electrically heating module further includes a thermally insulating plate, which is fixed between the electrically heating pipe and the main body, and which separates the first blade and the second blade, and which is arranged a perforation corresponding to the rotary axle.

6. The separable heating device of roasting oven according to claim 5, wherein the electrically heating module further includes a protecting plate, which is fixed under the thermally insulating plate, and which is arranged a plurality of ventilating holes corresponding to the second blade, while the electrically heating pipe is arranged between the thermally insulating plate and the protecting plate.

7. The separable heating device of roasting oven according to claim 1, wherein the open hole vertically penetrates the lid plate and a periphery of the open hole is closed, and wherein the quickly-releasing mechanism includes a wedge hook passing through the open hole and inter-wedged with the lid plate.

8. The separable heating device of roasting oven according to claim 7, wherein the electrically heating module includes a main body, and wherein the quickly-releasing mechanism further includes a slide block disposed beside the wedge hook and a position-limiting ring extended from one side of the main body, and the slide block and the wedge hook are accommodated between the position-limiting ring and the main body, and the slide block can be slid relatively to the main body, and the wedge hook is extended a rib abutted against the slide block and, through a sliding motion of the slide block relative to the main body, the rib is abutted by the slide block, making the wedge hook displaced and separating the lid plate.

9. The separable heating device of roasting oven according to claim 8, wherein the rib is shown as an inclining configuration.

10. The separable heating device of roasting oven according to claim 9, wherein the quickly-releasing mechanism further includes a compressive spring sandwiched and held between the wedge hook and the main body, and a side face of the wedge hook facing the main body is formed a positioning pillar adapted for being fitted in by the compressive spring.
